(19) United States
(12) Patent Application Publication
(10) Pub. No.: US 2026/0242277 A1
(43) Pub. Date: Aug. 20, 2026

(54) CHEMICALLY STRENGTHENED GLASS PLATE AND METHOD FOR PRODUCING SAME

(71) Applicant: Nippon Electric Glass Co., Ltd., Shiga (JP)

(72) Inventors: Kiyotaka KINOSHITA, Shiga (JP); Yoshinori NISHIKAWA, Shiga (JP)

(21) Appl. No.: 19/160,677

(22) PCT Filed: Feb. 28, 2024
(86) PCT No.: PCT/JP2024/007251

§ 371 Date: Aug. 28, 2025

(30) Foreign Application Priority Data
Mar. 13, 2023 (JP) 2023-038707

(51) Int. Cl. C03C 21/00; C03C 3/097

(52) U.S. Cl. CPC C03C 21/002; C03C 3/097; C03C 2203/50

(57) ABSTRACT

A chemically tempered glass sheet (1) includes a thin portion (2), a thick portion (3), and a compressive stress layer (6a, 6b) formed on a surface portion of each of the thin portion (2) and the thick portion (3), and is bendable at the thin portion (2). The chemically tempered glass sheet (1) has a relationship of DOC2>DOC1 and a relationship of DOC2/t2≥0.05, where DOC1 represents a maximum depth of compression of the thin portion (2), DOC2 represents a maximum depth of compression of the thick portion (3), and t2 represents a thickness of the thick portion (3).

### TECHNICAL FIELD

The present invention relates to a chemically tempered glass sheet and a method of producing the same.

### BACKGROUND ART

In recent years, there has been developed a device, such as a so-called foldable type smartphone or tablet PC, in which a display surface of a display can be folded. A cover glass of such a foldable device needs to be bendable. Accordingly, when a chemically tempered glass sheet is used as the cover glass, the chemically tempered glass sheet also needs to be bendable.

It is conceivable to thin the entirety of the chemically tempered glass sheet and to impart flexibility (softness) to the chemically tempered glass sheet for the purpose of making the chemically tempered glass sheet bendable. However, the chemically tempered glass sheet that is thinned throughout its entirety can be bent, but has a problem in that it is difficult to impart high impact resistance.

Meanwhile, when the entirety of the chemically tempered glass sheet is thickened, high impact resistance is easily imparted to the chemically tempered glass sheet, but flexibility is not easily imparted to the chemically tempered glass sheet. As a result, the chemically tempered glass sheet that is thickened throughout its entirety has a problem in that it is difficult to bend the sheet.

Accordingly, there has been developed a chemically tempered glass sheet that comprises a thin portion and a thick portion that is thicker than the thin portion, and is bendable at the thin portion (see, for example, Patent Literature 1).

### CITATION LIST

### Patent Literature

Patent Literature 1: WO 2020/065132 A1

### SUMMARY OF INVENTION

### Technical Problem

Even when a chemically tempered glass sheet comprises a thin portion and a thick portion and is bendable at the thin portion, there has been still room for improvement from the viewpoint of achieving both of high impact resistance and flexibility. In particular, in such chemically tempered glass sheets, when the impact resistance at one of the thick portion and the thin portion is increased, the impact resistance at the other portion is liable to be reduced.

For example, when ion exchange is performed to a deep portion by single ion exchange treatment to increase the depth of a compressive stress layer (depth of compression: DOC) for the purpose of increasing the impact resistance at the thick portion, ions are excessively diffused throughout the entire region in the thickness direction of the glass at the thin portion, a difference in ion concentration between the center and the surface portion of the glass is less likely to occur, and a high compressive stress may not be obtained on the surface of the thin portion. In contrast, when the depth of ion exchange is set to a shallow level for the purpose of achieving a high compressive stress on the surface of the thin portion, the DOC of the thick portion may become shallow. Thus, in the related art, it is difficult to achieve high impact resistance simultaneously at both the thick portion and the thin portion.

An object of the present invention is to provide a chemically tempered glass sheet having high impact resistance and flexibility.

### Solution to Problem

(1) According to one aspect of the present invention, which has been devised to achieve the above-mentioned object, there is provided a chemically tempered glass sheet comprising: a thin portion; a thick portion thicker than the thin portion; and a compressive stress layer formed on a surface portion of each of the thin portion and the thick portion, the chemically tempered glass sheet being bendable at the thin portion, wherein the chemically tempered glass sheet has a relationship of DOC2>DOC1 and a relationship of DOC2/t2≥0.05, where DOC1 represents a maximum depth of compression of the thin portion, DOC2 represents a maximum depth of compression of the thick portion, and t2 represents a thickness of the thick portion.

With this configuration, the maximum depth of compression DOC2 of the thick portion is larger than the maximum depth of compression DOC1 of the thin portion (DOC2>DOC1). In addition, the maximum depth of compression DOC2 of the thick portion is a depth sufficient for the thickness of the thick portion (DOC2/t2≥0.05). Accordingly, the compressive stress layer can be formed to an appropriate depth according to the thickness of each of the thin portion and the thick portion. That is, high impact resistance can be achieved at each of the thin portion and the thick portion while flexibility is imparted to the chemically tempered glass sheet by the thin portion.

(2) In the configuration of the above-mentioned item (1), the chemically tempered glass sheet preferably has a relationship of DOC1/t1≤0.20, where DOC1 represents the maximum depth of compression of the thin portion and t1 represents a thickness of the thin portion.

In the case of the thin portion, there is a small amount of inner glass that suppresses the volume expansion of an ion exchange portion. Thus, when the maximum depth of compression DOC1 is excessively large, it is difficult to increase a maximum compressive stress value CS1. Accordingly, the maximum depth of compression DOC1 of the thin portion is preferably 20% or less of the thickness t1 of the thin portion (DOC1/t1≤0.20). With this configuration, it becomes easy to increase the maximum compressive stress value CS1 of the thin portion to improve the impact resistance at the thin portion.

(3) In the configuration of the above-mentioned item (1) or (2), the thickness t1 of the thin portion is preferably 0.01 mm or more and 0.2 mm or less, and the thickness t2 of the thick portion is preferably more than 0.2 mm and 2.0 mm or less.

With this configuration, the thin portion becomes sufficiently thin, and hence the flexibility of the chemically tempered glass sheet is easily increased. In addition, the thick portion becomes sufficiently thick, and hence the impact resistance of the entire chemically tempered glass sheet is easily increased.

(4) In the configuration of any one of the above-mentioned items (1) to (3), the chemically tempered glass sheet preferably has a relationship of DOC2/DOC1≥5, where DOC1 represents the maximum depth of compression of the thin portion and DOC2 represents the maximum depth of compression of the thick portion.

With this configuration, higher impact resistance can be achieved at each of the thin portion and the thick portion.

(5) In the configuration of any one of the above-mentioned items (1) to (4), the maximum depth of compression DOC1 of the thin portion is preferably from 2 μm to 20 μm, and the maximum depth of compression DOC2 of the thick portion is preferably from 10 μm to 200 μm.

With this configuration, higher impact resistance can be achieved at each of the thin portion and the thick portion.

(6) In the configuration of any one of the above-mentioned items (1) to (5), a maximum compressive stress value CS1 of the thin portion is preferably from 100 MPa to 1, 500 MPa, and a maximum compressive stress value CS2 of the thick portion is preferably from 200 MPa to 2,000 MPa.

With this configuration, higher impact resistance can be achieved at each of the thin portion and the thick portion.

(7) In the configuration of any one of the above-mentioned items (1) to (6), the chemically tempered glass sheet preferably has a relationship of CS2/CS1≤20, where CS1 represents a maximum compressive stress value of the thin portion and CS2 represents a maximum compressive stress value of the thick portion.

With this configuration, higher impact resistance can be achieved at each of the thin portion and the thick portion.

(8) In the configuration of any one of the above-mentioned items (1) to (7), a stress profile in a depth direction of the compressive stress layer of the thick portion preferably has a bending point.

With this configuration, the maximum tensile stress value CT2 of the thick portion can be reduced while the maximum depth of compression DOC2 of the thick portion is increased.

(9) In the configuration of any one of the above-mentioned items (1) to (8), the chemically tempered glass sheet preferably comprises as a glass composition Li₂O and Na₂O.

With this configuration, the chemically tempered glass sheet having the above-mentioned stress characteristics is easily produced by performing ion exchange treatment a plurality of times (e.g., twice). Specifically, the chemically tempered glass sheet having the above-mentioned stress characteristics is easily produced by using, for example, a molten salt containing NaNO₃ and a molten salt containing KNO₃.

(10) In the configuration of the above-mentioned item (9), the chemically tempered glass sheet preferably comprises as the glass composition, in terms of mol %, 50% to 80% of SiO₂, 8% to 25% of Al₂O₃, 0% to 10% of B₂O₃, 3% to 15% of Li₂O, 3% to 21% of Na₂O, 0% to 10% of K₂O, 0% to 10% of MgO, and 0% to 15% of P₂O₅.

With this configuration, the chemically tempered glass sheet having the above-mentioned stress characteristics is easily produced by performing ion exchange treatment a plurality of times (e.g., two stages).

(11) According to one aspect of the present invention, which has been devised to achieve the above-mentioned object, there is provided a method of producing a chemically tempered glass sheet comprising a thin portion, a thick portion thicker than the thin portion, and a compressive stress layer formed on a surface portion of each of the thin portion and the thick portion, the chemically tempered glass sheet being bendable at the thin portion, the method comprising: a preparation step of preparing a glass to be tempered comprising the thick portion and the thin portion; and an ion exchange treatment step of subjecting the glass to be tempered to two-stage ion exchange treatment, wherein the ion exchange treatment step comprises performing the two-stage ion exchange treatment so that the chemically tempered glass sheet after the ion exchange treatment satisfies a relationship of DOC2>DOC1 and a relationship of DOC2/t2≥0.05, where DOC1 represents a maximum depth of compression of the thin portion, DOC2 represents a maximum depth of compression of the thick portion, and t2 represents a thickness of the thick portion.

With this configuration, the chemically tempered glass sheet having high impact resistance and flexibility can be provided.

(12) In the configuration of the above-mentioned item (11), the glass sheet to be tempered preferably comprises as a glass composition Li₂O and Na₂O, and the ion exchange treatment step preferably comprises: a first ion exchange treatment of performing ion exchange with a molten salt containing 10% or more of NaNO₃; and after the first ion exchange treatment, a second ion exchange treatment of performing ion exchange with a molten salt containing 30% or more of KNO₃.

With this configuration, the maximum compressive stress value CS1 can be increased by K ion exchange at the thin portion. In addition, at the thick portion, the maximum compressive stress value CS2 can be increased by K ion exchange while the maximum depth of compression DOC2 is increased by Na ion exchange.

The present invention may include the following aspect as another aspect.

(13) According to another aspect of the present invention, there is provided a chemically tempered glass sheet, comprising: a thin portion; a thick portion thicker than the thin portion; and a compressive stress layer formed on a surface portion of each of the thin portion and the thick portion, the chemically tempered glass sheet being bendable at the thin portion, wherein the thin portion has a thickness t1 of 0.2 mm or less, and wherein a stress profile in a depth direction of the compressive stress layer of the thick portion has a bending point.

### Advantageous Effects of Invention

According to the present invention, the chemically tempered glass sheet having high impact resistance and flexibility can be provided.

### BRIEF DESCRIPTION OF DRAWINGS

FIG. 1 is a plan view of a chemically tempered glass sheet according to an embodiment of the present invention.

FIG. 2 is a cross-sectional view taken along the line A-A of FIG. 1.

FIG. 3 is a cross-sectional view for illustrating a periphery of a thin portion of FIG. 2 on a larger scale, and is a view for illustrating a compressive stress layer and a tensile stress layer at the thin portion and a thick portion.

FIG. 4 is an example of a stress profile of the thick portion.

### DESCRIPTION OF EMBODIMENTS

A chemically tempered glass sheet and a method of producing the same according to an embodiment of the present invention are described below.

### (Chemically Tempered Glass Sheet)

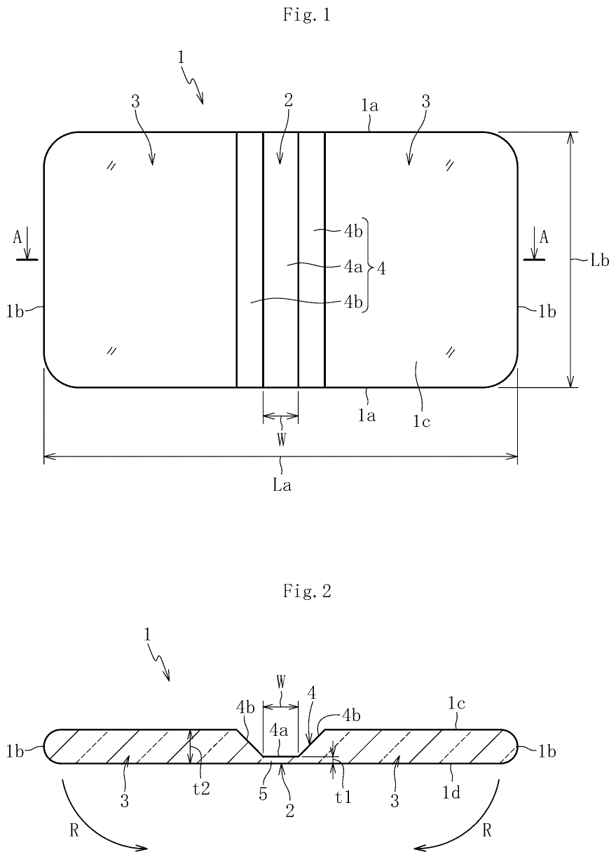

A chemically tempered glass sheet 1 according to this embodiment comprises a thin portion 2 and a thick portion 3 that is thicker than the thin portion 2 as illustrated in FIG. 1 and FIG. 2.

In this embodiment, a case in which the chemically tempered glass sheet 1 has a rectangular shape having long sides 1a and short sides 1b in plan view is taken as an example. A length La of each of the long sides 1a of the chemically tempered glass sheet 1 is preferably 50 mm or more and 500 mm or less, 65 mm or more and 450 mm or less, 60 mm or more and 400 mm or less, 70 mm or more and 300 mm or less, 75 mm or more and 200 mm or less, or 80 mm or more and 160 mm or less. A length Lb of each of the short sides 1b of the chemically tempered glass sheet 1 is preferably 40 mm or more and 400 mm or less, 45 mm or more and 350 mm or less, 50 mm or more and 300 mm or less, 55 mm or more and 120 mm or less, or 60 mm or more and 80 mm or less.

The chemically tempered glass sheet 1 is bendable at the thin portion 2. The chemically tempered glass sheet 1 has such flexibility that the sheet has a minimum bending radius of 10 mm or less without breakage at the time of its bending at the thin portion 2.

The thin portion 2 partitions the thick portion 3 into two portions. The two partitioned thick portions 3 are connected to each other via the thin portion 2. In other words, the thin portion 2 extends in a band shape from one end of the chemically tempered glass sheet 1 to the other end thereof. More specifically, the thin portion 2 is arranged parallel to the short sides 1b so as to traverse the main surface of the chemically tempered glass sheet 1 from the center of one long side 1a to the center of the other long side 1a.

The two thick portions 3 are preferably shaped to be line symmetric to each other with respect to the thin portion 2. With this configuration, the chemically tempered glass sheet 1 can be bent so that the two thick portions 3 are superposed, and is suitable for applications such as a foldable device.

A thickness t1 of the thin portion 2 is preferably 0.01 mm or more and 0.2 mm or less, 0.01 mm or more and 0.15 mm or less, 0.01 mm or more and 0.095 mm or less, 0.02 mm or more and 0.085 mm or less, or 0.03 mm or more and 0.075 mm or less. With this configuration, the flexibility and impact resistance of the thin portion 2 are easily secured. When the thickness t1 of the thin portion 2 is excessively small, the mechanical strength is reduced. In addition, an increase in compressive stress value of the surface becomes difficult. As a result, the flexibility may be impaired contrarily.

The thickness t1 of the thin portion 2 is preferably constant. When the thickness of the thin portion 2 is not constant, the thickness of the thinnest portion (minimum thickness) of the thin portion 2 may be determined as t1.

A width W of the thin portion 2 is preferably 3 mm or more and 50 mm or less, or 5 mm or more and 30 mm or less. With this configuration, a range of motion required to bend the chemically tempered glass sheet 1 can be sufficiently secured. The width W of the thin portion 2 is preferably constant.

A thickness t2 of the thick portion 3 is preferably more than 0.2 mm and 2.0 mm or less, more than 0.2 mm and 0.8 mm or less, more than 0.2 mm and 0.7 mm or less, more than 0.2 mm and 0.65 mm or less, or more than 0.2 mm and 0.6 mm or less. With this configuration, the deformability of the thick portion 3 can be appropriately suppressed to improve handleability at the time of the assembly and production of a device.

The thickness t2 of the thick portion 3 is preferably constant. When the thickness of the thick portion 3 is not constant, the thickness of the thickest portion (maximum thickness) of the thick portion 3 may be determined as t2.

The chemically tempered glass sheet 1 has a recessed groove 4 on the one main surface 1c side. The recessed groove 4 comprises a bottom surface 4a including a plane parallel to the main surfaces 1c and 1d, and side surfaces 4b including planes inclined with respect to the main surfaces 1c and 1d. The shape of the recessed groove 4 is not particularly limited. The side surfaces 4b may each be, for example, a plane perpendicular to the main surfaces 1c and 1d or a concave curved surface that is recessed on the main surface 1d side. The bottom surface 4a may be, for example, a concave curved surface that is recessed on the main surface 1d side.

The thin portion 2 comprises a remaining portion 5 on the other main surface 1d side that is formed at a position corresponding to the recessed groove 4. The chemically tempered glass sheet 1 is bendable, for example, in such a direction that the recessed groove 4 side faces outward (an arrow R direction of FIG. 2). When the chemically tempered glass sheet 1 is bendable in such direction, a flat surface without the recessed groove 4 may be a touch surface of a foldable device, and hence the touch surface can be protected at the time of the folding of the foldable device. The thin portion 2 may be formed by forming the recessed groove 4 on the main surfaces 1c and 1d.

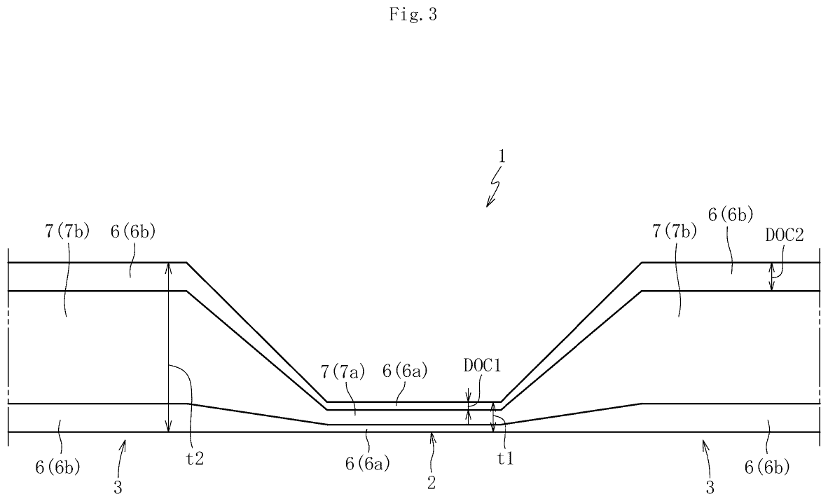

As illustrated in FIG. 3, the chemically tempered glass sheet 1 comprises a compressive stress layer 6 formed on a surface portion having a surface, and a tensile stress layer 7 formed on an inner side with respect to the compressive stress layer 6 (on a central side in the sheet thickness direction). In this embodiment, the compressive stress layer 6 includes a compressive stress layer 6a formed at the thin portion 2 and a compressive stress layer 6b formed at the thick portion 3. The tensile stress layer 7 includes a tensile stress layer 7a formed at the thin portion 2 and a tensile stress layer 7b formed at the thick portion 3. The thin portion 2 and the thick portion 3 have different stress characteristics.

A maximum depth of compression DOC1 of the thin portion 2 is smaller than a maximum depth of compression DOC2 of the thick portion 3. That is, a relationship of DOC1<DOC2 is established. With this configuration, the depth of the compressive stress layer 6a at the thin portion 2 is relatively small, and the depth of the compressive stress layer 6b at the thick portion 3 is relatively large. Accordingly, the depths of the compressive stress layers 6a and 6b are adjusted according to the thicknesses of the thin portion 2 and the thick portion 3, respectively, and high impact resistance is easily achieved at each of the thin portion 2 and the thick portion 3. DOC1 represents the depth of the compressive stress layer 6a at the thin portion 2, and DOC2 represents the depth of the compressive stress layer 6b at the thick portion 3. When the thickness of the thin portion 2 is not constant, the maximum depth of compression of the thinnest portion of the thin portion 2 (i.e., a portion with a thickness t1) may be determined as DOC1. CS1 and CT1 to be described later may be determined at the same portion as where DOC1 is determined.

The lower limit range of DOC2/DOC1 is preferably 5 or more, 7 or more, or 10 or more. With this configuration, the depths of the compressive stress layers 6a and 6b are easily optimized according to the thicknesses of the thin portion 2 and the thick portion 3, respectively. Meanwhile, the upper limit range of DOC2/DOC1 is preferably 200 or less, 100 or less, or 50 or less. DOC2/DOC1 represents a value obtained by dividing the maximum depth of compression DOC2 of the thick portion 3 by the maximum depth of compression DOC1 of the thin portion 2.

The lower limit range of the maximum depth of compression DOC1 of the thin portion 2 is preferably 2 μm or more, 3 μm or more, 4 μm or more, or 5 μm or more. The upper limit range of the maximum depth of compression DOC1 of the thin portion 2 is preferably 20 μm or less, 15 μm or less, or 10 μm or less. The lower limit range of the maximum depth of compression DOC2 of the thick portion 3 is preferably 10 μm or more, 30 μm or more, 40 μm or more, 50 μm or more, or 80 μm or more. The upper limit range of the maximum depth of compression DOC2 of the thick portion 3 is preferably 200 μm or less, or 150 μm or less.

The lower limit range of DOC2/t2 is preferably 0.05 or more, 0.08 or more, 0.10 or more, 0.12 or more, or 0.15 or more. With this configuration, the proportion of the compressive stress layer 6b in the thick portion 3 is significantly increased, and hence high impact resistance can be achieved. Meanwhile, the upper limit range of DOC2/t2 is preferably 0.3 or less, 0.25 or less, or 0.23 or less. With this configuration, an excessive increase in proportion of the compressive stress layer 6b in the thick portion 3 is suppressed, and hence the maximum compressive stress value CS2 of the thick portion 3 is easily increased. DOC2/t2 represents a value obtained by dividing the maximum depth of compression DOC2 of the thick portion 3 by the thickness t2 of the thick portion 3.

The lower limit range of DOC1/t1 is preferably 0.01 or more, 0.02 or more, or 0.05 or more. With this configuration, the proportion of the compressive stress layer 6b in the thick portion 3 is significantly increased, and hence high impact resistance can be achieved. Meanwhile, the upper limit range of DOC1/t1 is preferably 0.02 or less, 0.10 or less, 0.08 or less, or 0.05 or less. With this configuration, an excessive increase in proportion of the compressive stress layer 6a in the thin portion 2 is suppressed, and hence the maximum compressive stress value CS1 of the thin portion 2 is easily increased. In particular, in the case of the thin portion 2, there is a small amount of inner glass that suppresses the volume expansion of an ion exchange portion. Thus, when the maximum depth of compression DOC1 is excessively increased, it becomes difficult to increase the maximum compressive stress value CS1. DOC1/t1 represents a value obtained by dividing the maximum depth of compression DOC1 of the thin portion 2 by the thickness t1 of the thin portion 2.

Between DOC2/t2 and DOC1/t1, a relationship of DOC2/t2>DOC1/t1 may be established. For example, DOC2/t2 may be 1.3 times or more, 1.5 times or more, or 2 times or more as large as DOC1/t1.

When the maximum compressive stress value of the thin portion 2 is represented by CS1 and the maximum compressive stress value of the thick portion 3 is represented by CS2, the upper limit range of CS2/CS1 is preferably 20 or less, 15 or less, 12 or less, 10 or less, 5 or less, 4 or less, 2 or less, or 1.5 or less. The lower limit range of CS2/CS1 is preferably 1 or more, 1.05 or more, or 1.1 or more. With this configuration, the impact resistance of each of the thin portion 2 and the thick portion 3 is easily further increased. The maximum compressive stress value CS1 is a compressive stress value of the surface of the thin portion 2. The maximum compressive stress value CS2 is a compressive stress value of the surface of the thick portion 3. CS2/CS1 represents a value obtained by dividing the maximum compressive stress value CS2 of the thick portion 3 by the maximum compressive stress value CS1 of the thin portion 2.

The lower limit range of the maximum compressive stress value CS1 of the thin portion 2 is preferably 100 MPa or more, 200 MPa or more, 300 MPa or more, 400 MPa or more, or 500 MPa or more. The upper limit range of the maximum compressive stress value CS1 of the thin portion 2 is preferably 1, 500 MPa or less, 1,300 MPa or less, 1,100 MPa or less, 1,000 MPa or less, or 900 MPa or less.

The lower limit range of the maximum compressive stress value CS2 of the thick portion 3 is preferably 200 MPa or more, 300 MPa or more, 400 MPa or more, 500 MPa or more, 600 MPa or more, 700 MPa or more, 800 MPa or more, or 900 MPa or more. The upper limit range of the maximum compressive stress value CS2 of the thick portion 3 is preferably 2,000 MPa or less, 1,500 MPa or less, 1, 300 MPa or less, or 1,200 MPa or less.

The upper limit range of the maximum tensile stress value CT1 of the thin portion 2 is preferably 1,000 MPa or less, 500 MPa or less, 400 MPa or less, 285 MPa or less, 250 MPa or less, 240 MPa or less, 230 MPa or less, 220 MPa or less, 210 MPa or less, 200 MPa or less, 190 MPa or less, 180 MPa or less, 170 MPa or less, 160 MPa or less, 150 MPa or less, 145 MPa or less, 140 MPa or less, 130 MPa or less, 120 MPa or less, 110 MPa or less, 100 MPa or less, 95 MPa or less, 85 MPa or less, or 70 MPa or less. Meanwhile, the lower limit range of the maximum tensile stress value CT1 of the thin portion 2 is preferably 20 MPa or more, 50 MPa or more, or 60 MPa or more. With this configuration, the strength against bending can be secured while safety that does not produce a dangerous breakage mode at the time of breakage is secured.

The upper limit range of the maximum tensile stress value CT2 of the thick portion 3 is preferably 1,000 MPa or less, 500 MPa or less, 400 MPa or less, 285 MPa or less, 250 MPa or less, 240 MPa or less, 230 MPa or less, 220 MPa or less, 210 MPa or less, 200 MPa or less, 190 MPa or less, 180 MPa or less, 170 MPa or less, 160 MPa or less, 150 MPa or less, 145 MPa or less, 140 MPa or less, 130 MPa or less, 120 MPa or less, 110 MPa or less, 100 MPa or less, 95 MPa or less, 85 MPa or less, or 70 MPa or less. Meanwhile, the lower limit range of the maximum tensile stress value CT2 of the thick portion 3 is preferably 20 MPa or more, 50 MPa or more, or 60 MPa or more. With this configuration, safety that does not produce a dangerous breakage mode at the time of breakage can be secured.

The numerical values related to stress, such as DOC1, DOC2, CS1, CS2, CT1, and CT2, may be derived by measuring the stress distribution of the chemically tempered glass sheet 1 with a measurement apparatus, such as FSM-6000 or SLP-2000 manufactured by Orihara Industrial Co., Ltd.

The entire surface of the chemically tempered glass sheet 1, that is, the main surfaces and the end surfaces including the thin portion 2 and the thick portion 3 are all preferably etched surfaces. When the entire surface is etched, defects are reduced over the entire surface, and high strength is achieved. The surface roughness Ra of the etched surface is, for example, from 10.0 nm to 0.1 nm. The main surface represents front and back surfaces excluding the end surfaces, of the entire surface of the sheet-shaped glass surface.

In this embodiment, the chemically tempered glass sheet 1 comprises as a glass composition Li₂O and Na₂O. With this configuration, the chemically tempered glass sheet 1 having above-mentioned stress characteristics is easily produced by performing ion exchange treatment a plurality of times (e.g., twice).

Specifically, the chemically tempered glass sheet 1 preferably comprises as the glass composition, in terms of mol %, 50% to 80% of SiO₂, 8% to 25% of Al₂O₃, 0% to 10% of B₂O₃, 3% to 15% of Li₂O, 3% to 21% of Na₂O, 0% to 10% of K₂O, 0% to 10% of MgO, and 0% to 15% of P₂O₅. The reasons why the content ranges of the components are restricted are described below. In the description of the content range of each component, the expression “%” means “mol %” unless otherwise specified.

SiO₂ is a component that forms a glass network. When the content of SiO₂ is too small, vitrification does not occur easily, and a thermal expansion coefficient becomes too high, with the result that thermal shock resistance is liable to be reduced. Accordingly, a suitable lower limit range of the content of SiO₂ is 50% or more, 55% or more, 57% or more, or 59% or more, particularly 61% or more. Meanwhile, when the content of SiO₂ is too large, meltability and formability are liable to be reduced, and the thermal expansion coefficient is excessively reduced, with the result that it becomes difficult to match the thermal expansion coefficient with those of peripheral materials. Accordingly, a suitable upper limit range of the content of SiO₂ is 80% or less, 70% or less, 68% or less, 66% or less, or 65% or less, particularly 64.5% or less.

Al₂O₃ is a component that improves ion exchange performance, and is also a component that increases a strain point, a Young's modulus, a fracture toughness, and a Vickers hardness. Accordingly, a suitable lower limit range of the content of Al₂O₃ is 8% or more, 10% or more, 12% or more, 13% or more, 14% or more, 14.4% or more, 15% or more, 15.3% or more, 15.6% or more, 16% or more, 16.5% or more, 17% or more, 17.2% or more, 17.5% or more, 17.8% or more, 18% or more, more than 18%, or 18.3% or more, particularly 18.5% or more, 18.6% or more, 18.7% or more, or 18.8% or more. Meanwhile, when the content of Al₂O₃ is too large, a viscosity at high temperature is increased, with the result that the meltability and the formability are liable to be reduced. In addition, a devitrified crystal is liable to be precipitated in the glass, and it becomes difficult to form the glass into a sheet shape by an overflow down-draw method or the like. Particularly when the glass is formed into a sheet shape by an overflow down-draw method involving using alumina-based refractory as forming body refractory, a devitrified crystal of spinel is liable to be precipitated at an interface with the alumina-based refractory. Further, acid resistance is reduced, with the result that it becomes difficult to subject the glass to an acid treatment step. Accordingly, a suitable upper limit range of the content of Al₂O₃ is 25% or less, 21% or less, 20.5% or less, 20% or less, 19.9% or less, 19.5% or less, or 19.0% or less, particularly 18.9% or less.

B₂O₃ is a component that reduces the viscosity at high temperature and a density, and stabilizes the glass to cause less precipitation of a crystal, to thereby reduce a liquidus temperature. When the content of B₂O₃ is too small, a depth of layer obtained through ion exchange between a Li ion in the glass and a Na ion in a molten salt is excessively increased, with the result that the maximum compressive stress value CS2 is liable to be reduced. In addition, there is a risk in that the glass may be unstable, and devitrification resistance may be reduced. Accordingly, a suitable lower limit range of the content of B₂O₃ is 0% or more, 0.01% or more, 0.05% or more, 0.1% or more, 0.2% or more, 0.5% or more, 0.6% or more, 0.7% or more, 0.8% or more, or 0.9% or more, particularly 1% or more. Meanwhile, when the content of B₂O₃ is too large, there is a risk in that the depth of layer may be reduced. In particular, the efficiency of ion exchange between a Na ion in the glass and a K ion in a molten salt is liable to be reduced, and the maximum depth of compression DOC is liable to be reduced. Accordingly, a suitable upper limit range of the content of B₂O₃ is 10% or less, 5% or less, 4% or less, 3.8% or less, 3.5% or less, 3.3% or less, 3.2% or less, 3.1% or less, or 3% or less, particularly 2.9% or less.

Li₂O is an ion exchange component, and particularly, is an essential component for increasing the maximum depth of compression DOC2 through ion exchange between a Li ion in the glass and a Na ion in the molten salt. In addition, Li₂O is a component that reduces the viscosity at high temperature to improve the meltability and the formability, and is also a component that increases the Young's modulus. Accordingly, a suitable lower limit range of the content of Li₂O is 3% or more, 4% or more, 5% or more, 5.5% or more, 6.5% or more, 7% or more, 7.3% or more, 7.5% or more, or 7.8% or more, particularly 8% or more. Accordingly, a suitable upper limit range of the content of Li₂O is 15% or less, 13% or less, 12% or less, 11.5% or less, 11% or less, 10.5% or less, or less than 10%, particularly 9.9% or less, 9% or less, or 8.9% or less.

Na₂O is an ion exchange component, and is also a component that reduces the viscosity at high temperature to improve the meltability and the formability. In addition, Na₂O is a component that improves the devitrification resistance, and is particularly a component that suppresses devitrification caused by a reaction with alumina-based refractory. Accordingly, a suitable lower limit range of the content of Na₂O is 3% or more, 4% or more, 5% or more, 6% or more, 7% or more, 7.5% or more, 8% or more, 8.5% or more, or 8.8% or more, particularly 9% or more. Meanwhile, when the content of Na₂O is too large, the thermal expansion coefficient is excessively increased, and the thermal shock resistance is liable to be reduced. In addition, the glass composition loses its component balance, and the devitrification resistance be may reduced contrarily. Accordingly, a suitable upper limit range of the content of Na₂O is 21% or less, 20% or less, or 19% or less, particularly 18% or less, 15% or less, 13% or less, or 11% or less, particularly 10% or less.

K₂O is a component that reduces the viscosity at high temperature to improve the meltability and the formability. However, when the content of K₂O is too large, the thermal expansion coefficient is excessively increased, and the thermal shock resistance is liable to be reduced. In addition, the compressive stress value of the compressive stress layer on the outermost surface is liable to be reduced. Accordingly, a suitable upper limit range of the content of K₂O is 10% or less, 7% or less, 6% or less, 5% or less, 4% or less, 3% or less, 2% or less, 1.5% or less, 1% or less, less than 18, or 0.5% or less, particularly less than 0.18. When the viewpoint of increasing the depth of layer is emphasized, a suitable lower limit range of the content of K₂O is 0% or more, 0.1% or more, or 0.3% or more, particularly 0.5% or more.

MgO is a component that reduces the viscosity at high temperature to improve the meltability and the formability, and increases the strain point and the Vickers hardness. Among alkaline earth metal oxides, MgO is a component that has a high improving effect on the ion exchange performance. However, when the content of MgO is too large, the devitrification resistance is liable to be reduced, and particularly, it becomes difficult to suppress devitrification caused by a reaction with alumina-based refractory. Accordingly, a suitable content of MgO is from 0% to 10%, from 0% to 5%, from 0.1% to 4%, or from 0.2% to 3.5%, particularly from 0.5% to less than 3%.

P₂O₅ is a component that improves the ion exchange performance, and particularly, is a component that increases the maximum depth of compression DOC2. Further, P₂O₅ is a component that also improves the acid resistance. When the content of P₂O₅ is too small, there is a risk in that the ion exchange performance cannot be sufficiently exhibited. In particular, the efficiency of ion exchange between a Na ion in the glass and a K ion in the molten salt is liable to be reduced. In addition, there is a risk in that the glass may be unstable, and the devitrification resistance may be reduced. Accordingly, a suitable lower limit range of the content of P₂O₅ is 0% or more, 0.1% or more, 0.4% or more, 0.7% or more, 1% or more, 1.2% or more, 1.4% or more, 1.6% or more, 2% or more, 2.3% or more, or 2.5% or more, particularly 3% or more. Meanwhile, when the content of P₂O₅ is too large, the glass undergoes phase separation, or water resistance is liable to be reduced. In addition, the depth of layer obtained through ion exchange between a Li ion in the glass and a Na ion in the molten salt is excessively increased, with the result that the maximum compressive stress value CS2 is liable to be reduced. Accordingly, a suitable upper limit range of the content of P₂O₅ is 15% or less, 10% or less, 5% or less, 4.5% or less, or 4% or less. In other words, in one aspect, the glass may be substantially free of P₂O₅.

An alkali metal oxide is an ion exchange component, and is also a component that reduces the viscosity at high temperature to improve the meltability and the formability. When the content of the alkali metal oxide ([Li₂O]+[Na₂O]+[K₂O]) is too large, there is a risk in that the thermal expansion coefficient may be increased. In addition, there is a risk in that the acid resistance may be reduced. Accordingly, a suitable lower limit range of the content of the alkali metal oxide ([Li₂O]+[Na₂O]+[K₂O]) is 10% or more, 11% or more, 12% or more, 13% or more, 14% or more, or 15% or more. Accordingly, a suitable upper limit range of the content of the alkali metal oxide ([Li₂O]+[Na₂O]+[K₂O]) is 25% or less, 23% or less, 20% or less, 19% or less, or 18% or less.

The molar ratio [Li₂O]/([Na₂O]+[K₂O]) is preferably from 0.4 to 1.0, or from 0.5 to 0.9, particularly preferably from 0.6 to 0.8. When the molar ratio [Li₂O]/([Na₂O]+[K₂O]) is too low, there is a risk in that the ion exchange performance cannot be sufficiently exhibited. In particular, the efficiency of ion exchange between a Li ion in the glass and a Na ion in the molten salt is liable to be reduced. Meanwhile, when the molar ratio [Li₂O]/([Na₂O]+[K₂O]) is too high, a devitrified crystal is liable to precipitate in the glass, and it becomes difficult to form the glass into a sheet shape by an overflow down-draw method or the like. “[Li₂O]/([Na₂O]+[K₂O])” refers to a value obtained by dividing the content of Li₂O by the total content of Na₂O and K₂O.

The molar ratio ([Na₂O]—[Li₂O])/([Al₂O₃]+[B₂O₃]+[P₂O₅]) is preferably 0.29 or less, 0.27 or less, 0.26 or less, 0.25 or less, 0.23 or less, or 0.20 or less, particularly preferably 0.15 or less. When the molar ratio ([Na₂O]—[Li₂O])/([Al₂O₃]+[B₂O₃]+[P₂O₅]) is too high, there is a risk in that the ion exchange performance cannot be sufficiently exhibited. In particular, the efficiency of ion exchange between a Li ion in the glass and a Na ion in the molten salt is liable to be reduced.

The molar ratio ([B₂O₃]+[Na₂O]—[P₂O₅])/([Al₂O₃]+[Li₂O]) is preferably 0.30 or more, 0.35 or more, 0.40 or more, 0.42 or more, or 0.43 or more, particularly preferably 0.45 or more. When the molar ratio ([B₂O₃]+[Na₂O]—[P₂O₅])/([Al₂O₃]+[Li₂O]) is too low, a devitrified crystal is liable to precipitate in the glass, and it becomes difficult to form the glass into a sheet shape by an overflow down-draw method or the like.

([SiO₂]+1.2×[P₂O₅]−3×[Al₂O₃]−2×[Li₂O]−1.5×[Na₂O]—[K₂O]—[B₂O₃]) is preferably −40% or more, −30% or more, −25% or more, −24% or more, −23% or more, −22% or more, −21% or more, 20% or more, or −19% or more, particularly preferably −18% or more. When the ([SiO₂]+1.2×[P₂O₅]-3×[Al₂O₃]−2×[Li₂O]−1.5×[Na₂O]—[K₂O]—[B₂O₃]) is too low, the acid resistance is liable to be reduced. Meanwhile, when the ([SiO₂]+1.2×[P₂O₅]-3×[Al₂O₃]-2×[Li₂O]−1.5×[Na₂O]—[K₂O]—[B₂O₃]) is too high, there is a risk in that the ion exchange performance cannot be sufficiently exhibited. Accordingly, the ([SiO₂]+1.2×[P₂O₅]-3×[Al₂O₃]—2×[Li₂O]−1.5×[Na₂O]—[K₂O]—[B₂O₃]) is preferably 30 mol % or less, 20 mol % or less, 15 mol % or less, 10 mol % or less, or 5 mol % or less, particularly preferably 0 mol % or less.

For example, the following components other than the above-mentioned components may be added.

Cao is a component that reduces the viscosity at high temperature to improve the meltability and the formability without reducing the devitrification resistance as compared to other components, and increases the strain point and the Vickers hardness. However, when the content of Cao is too large, there is a risk in that the ion exchange performance may be reduced, or an ion exchange solution may be degraded at the time of ion exchange treatment. Accordingly, a suitable upper limit range of the content of CaO is 6% or less, 5% or less, 4% or less, 3.5% or less, 3% or less, 2% or less, 1% or less, less than 1%, or 0.5% or less, particularly less than 0.1%.

SrO and BaO are each a component that reduces the viscosity at high temperature to improve the meltability and the formability, and increases the strain point and the Young's modulus. However, when the contents of SrO and BaO are too large, an ion exchange reaction is liable to be inhibited. In addition, the density or the thermal expansion coefficient is increased inappropriately, or the glass is liable to devitrify. Accordingly, suitable contents of Sro and BaO are each from 0% to 2%, from 0% to 1.5%, from 0% to 1%, from 0% to 0.5%, or from 0% to 0.1%, particularly from 0% to less than 0.1%.

ZnO is a component that improves the ion exchange performance, and particularly, is a component that has a high increasing effect on the maximum compressive stress value CS2. In addition, ZnO is a component that reduces viscosity at high temperature without reducing viscosity at low temperature. A suitable lower limit range of the content of ZnO is 0% or more, 0.1% or more, 0.3% or more, 0.5% or more, or 0.7% or more, particularly 1% or more. Meanwhile, when the content of ZnO is too large, there is a tendency that the glass undergoes phase separation, the devitrification resistance is reduced, the density is increased, or the depth of layer is reduced. Accordingly, a suitable upper limit range of the content of ZnO is 10% or less, 6% or less, 5% or less, 4% or less, 3% or less, 2% or less, 1.5% or less, 1.3% or less, or 1.2% or less, particularly 1.1% or less.

ZrO₂ is a component that increases the Vickers hardness, and is also a component that increases viscosity around the liquidus viscosity and the strain point. However, when the content of ZrO₂ is too large, there is a risk in that the devitrification resistance is remarkably reduced. Accordingly, a suitable content of ZrO₂ is from 0% to 3%, from 0% to 1.5%, or from 0% to 18, particularly from 0% to 0.1%.

TiO₂ is a component that improves the ion exchange performance, and is also a component that reduces the viscosity at high temperature. However, when the content of TiO₂ is too large, transparency and the devitrification resistance are liable to be reduced. Accordingly, a suitable content of TiO₂ is from 0% to 3%, from 0% to 1.5%, from 0% to 1%, or from 0% to 0.1%, particularly from 0.001% to 0.1%.

SnO₂ is a component that improves the ion exchange performance. However, when the content of SnO₂ is too large, the devitrification resistance is liable to be reduced. Accordingly, a suitable lower limit range of the content of SnO₂ is 0.005% or more, or 0.01% or more, particularly 0.1% or more, and a suitable upper limit range thereof is 3% or less, or 2% or less, particularly 1% or less.

Cl is a fining agent, but is a component that adversely affects an environment or a facility when the content thereof is too large. Accordingly, a suitable lower limit range of the content of Cl is 0.001% or more, particularly 0.01% or more, and a suitable upper limit range thereof is 0.3% or less, or 0.2% or less, particularly 0.1% or less.

The Young's modulus of the chemically tempered glass sheet 1 is preferably from 70 GPa to 100 GPa, or from 75 GPa to 100 GPa, particularly preferably from 76 GPa to 90 GPa. When the Young's modulus is small, the cover glass is liable to be deflected in the case of having a small thickness. The “Young's modulus” may be calculated by a well-known resonance method.

### <Method of Producing Chemically Tempered Glass Sheet>

A method of producing the chemically tempered glass sheet 1 comprises: a preparation step of preparing a glass sheet to be chemically tempered; and an ion exchange treatment step of subjecting the glass sheet to be chemically tempered to ion exchange treatment.

In the preparation step, the glass sheet to be chemically tempered is prepared. The glass sheet to be chemically tempered is a glass sheet that has the same shape, size, and glass composition as those of the above-mentioned chemically tempered glass sheet 1 and has not been tempered. In other words, the glass sheet to be chemically tempered comprises Li₂O and Na₂O as a glass composition and is rectangular.

The glass sheet to be chemically tempered is obtained by cutting, into small glass pieces, a sheet-shaped mother glass that is obtained, for example, by a forming method, such as an overflow down-draw method, a slot down-draw method, a float method, or a redraw method, and processing the small glass pieces. The overflow down-draw method is preferably used as the forming method to obtain a smooth surface.

The small glass pieces cut out are each subjected to processing of forming a recessed groove to form the thin portion 2. The recessed groove is formed by processing, such as etching or grinding. The processing to form a recessed groove is performed before the ion exchange treatment step.

An end surface of the glass sheet to be chemically tempered is preferably subjected to chamfering or treatment for improving the strength by polishing, heat treatment, etching, or the like.

The main surface of the glass sheet to be chemically tempered may be subjected to polishing treatment. Alternatively, for example, when the main surface is smoothly formed in advance by the overflow down-draw method or when the main surface is precisely formed with a uniform thickness, the main surface of the glass sheet to be chemically tempered may be an unpolished surface that is not subjected to polishing treatment. The unpolished surface formed by the overflow down-draw method is a forged surface. A glass to be chemically tempered may be subjected to slimming treatment that further reduces the thickness by etching.

In the ion exchange treatment step, the glass sheet to be chemically tempered obtained as described above is subjected to ion exchange treatment a plurality of times. The plurality of times of the ion exchange treatment comprises: first ion exchange treatment of immersing sheet to be chemically tempered in a first molten salt containing 10 mass % or more of NaNO₃; and after the first ion exchange treatment, second ion exchange treatment of immersing the glass sheet to be chemically tempered in a second molten salt containing 30 mass % or more of KNO₃.

In the first ion exchange treatment, the concentration of NaNO₃ in the first molten salt is preferably 10 mass % or more, 20 mass % or more, 30 mass % or more, 50 mass % or more, or 70 mass % or more. The first molten salt may be a molten salt formed of only NaNO₃, a mixed molten salt of NaNO₃ and KNO₃, or the like. When the mixed molten salt of NaNO₃ and KNO₃ is used as the first molten salt, the KNO₃ concentration is preferably 0 mass % or more, 1 mass % or more, 5 mass % or more, 7 mass % or more, 10 mass % or more, 15 mass % or more, or from 20 mass % to 90 mass %. The KNO₃ concentration is preferably higher than the NaNO₃ concentration. When the KNO₃ concentration is too high, there is a risk in that the compressive stress value produced during ion exchange between a Li ion in the glass and a Na ion in the molten salt may be excessively reduced. Meanwhile, when the KNO₃ concentration is too low, there is a risk in that the measurement of a stress with a surface stress meter FSM-6000 becomes difficult.

In the first ion exchange treatment, the first molten salt contains NaNO₃, and hence a Li ion in the glass and a Na ion in the molten salt are ion exchanged with each other. When the mixed molten salt of NaNO₃ and KNO₃ is used as the first molten salt, a Na ion in the glass and a K ion in the molten salt are ion exchanged with each other in addition to the above-mentioned ion exchange. Herein, the ion exchange between a Li ion in the glass and a Na ion in the molten salt is faster and more efficient than the ion exchange between a Na ion in the glass and a K ion in the molten salt.

In this case, when the conditions of the first ion exchange treatment are set with reference to the thin portion of the glass sheet to be chemically tempered, the maximum depth of compression of the thin portion can be appropriately set with respect to the thickness of the thin portion. However, at the thick portion of the glass sheet to be chemically tempered, a Na ion is not diffused to a sufficient depth for the thickness of the thick portion. As a result, the maximum depth of compression of the thick portion is too small with respect to the thickness of the thick portion. In this case, for example, the strength of the thick portion against breakage caused by press-fitting a projection and the like may be reduced.

Accordingly, in this embodiment, the conditions of the first ion exchange treatment are set with reference to the thick portion. Thus, at the thick portion of the glass sheet to be chemically tempered, a Na ion is diffused to a sufficient depth for the thickness of the thick portion. As a result, the maximum depth of compression of the thick portion is optimized with respect to the thickness of the thick portion. In this case, a Na ion is diffused to an excessive depth with respect to the thickness of the thin portion, and no gradient is generated in the concentration distribution of a Na ion in the thickness direction of the thin portion. The compressive stress layer is formed owing to the gradient of the concentration distribution of a diffused ion, and hence the thin portion is not sufficiently tempered by the first ion exchange treatment. Accordingly, in this embodiment, the thick portion is tempered by the first ion exchange treatment and the second ion exchange treatment, and the thin portion is further tempered by the second ion exchange treatment.

In the second ion exchange treatment, the concentration of KNO₃ in the second molten salt is preferably 30 mass % or more, 50 mass % or more, 70 mass % or more, or 90 mass or more. The second molten salt may be a molten salt formed of only KNO₃, a mixed molten salt of KNO₃ and NaNO₃, or the like. When the mixed molten salt of KNO₃ and NaNO₃ is used as the second molten salt, the NaNO₃ concentration is preferably from more than 0 mass % to 5 mass %, from more than 0 mass % to 3 mass %, from more than 0 mass % to 2 mass %, or from 0.5 mass % to 2 mass %. The KNO₃ concentration is preferably higher than the NaNO₃ concentration. When the NaNO₃ concentration is too low, a Na ion in the vicinity of the glass surface is liable to be released, which causes a reduction in stress. Meanwhile, when the NaNO₃ concentration is too high, there is a risk in that the compressive stress value produced by ion exchange between a Na ion in the vicinity of the glass surface and a K ion in the molten salt may be excessively reduced.

The second molten salt may be a mixed molten salt of KNO₃, NaNO₃, and LiNO₃, or a mixed molten salt of KNO₃ and LiNO₃. In any case, the content of KNO₃ in the second molten salt is preferably higher than that of any other salt.

In the second ion exchange treatment, the second molten salt contains KNO₃, and hence a Na ion in the vicinity of the glass surface (at a shallow region up to 20% of the thickness of the sheet from the outermost surface) and a K ion in the molten salt are ion exchanged with each other. When the mixed molten salt of KNO₃ and LiNO₃ is used as the second molten salt, a Na ion in the vicinity of the glass surface and a Li ion in the molten salt are ion exchanged with each other in addition to the above-mentioned ion exchange. That is, in the second ion exchange treatment, a K ion, which has a large ionic radius, can be introduced while a Na ion in the vicinity of the glass surface is released.

In this case, at the thick portion, while the maximum depth of compression, which is relatively large, formed by the first ion exchange treatment is maintained, the maximum compressive stress value can be increased by introduction of a K ion. Meanwhile, at the thin portion, while the maximum depth of compression, which is relatively small, is formed, the maximum compressive stress value can be increased by introduction of a K ion. That is, the chemically tempered glass sheet 1 thus produced through the ion exchange treatment step has different stress characteristics (DOC1<DOC2, and the like) at the thick portion 3 and the thin portion 2. At the thick portion 3, a gradient is present in the concentration distributions of a K ion and a Na ion. Meanwhile, at the thin portion 2, a gradient is present in the concentration distribution of a K ion, but substantially no gradient is present in the concentration distribution of a Na ion. In other words, at the thick portion 3, each of the concentration distributions of a K ion and a Na ion exhibits a reduction trend toward the center of the thickness of the sheet. Meanwhile, at the thin portion 2, the concentration distribution of a K ion exhibits a reduction trend toward the center of the thickness of the sheet, but the concentration distribution of a Na ion does not greatly change toward the center of the thickness of the sheet, and is substantially constant. Here, the term “concentration distribution exhibiting a reduction trend” includes a case in which when the concentration distribution has a reduction trend as a whole, there is an inflection point (bottom) at which the trend shifts from reduction to increase on the way toward the center of the thickness of the sheet or an inflection point (peak) at which the trend shifts from increase to reduction.

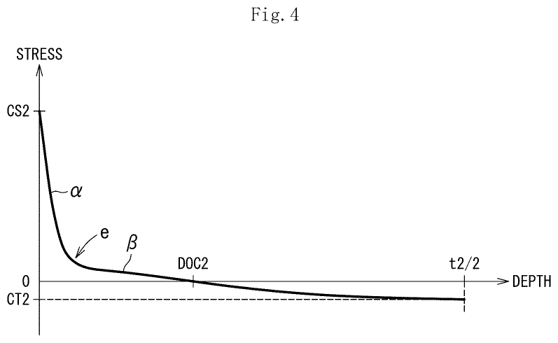

A stress profile in the depth direction of the compressive stress layer of the thick portion 3 after the above-mentioned second ion exchange treatment has a bending point “e” as shown in FIG. 4. In FIG. 4, the vertical axis represents a compressive stress value, and the vertical axis represents the depth from the surface of the chemically tempered glass sheet 1. As shown in FIG. 4, the stress profile of the thick portion 3 has a maximum compressive stress value CS2 in the surface, and reduces to the bending point “e” with a relatively steep gradient a in the depth direction. Further, the compressive stress value in the same stress profile gradually reduces from the bending point “e” to the depth DOC2 with a relatively gentle gradient B. According to such stress profile, both of a high maximum compressive stress value CS2 and a low maximum tensile stress value CT2 can be achieved at the thick portion 3, and high impact resistance can be achieved. For example, when the stress profile can be approximated by a broken line formed by two straight lines, the bending point “e” can be determined as a point on the stress profile at the depth of the intersection point between the two straight lines (a point at which the broken line is bent). In approximation of a straight line, for example, a known procedure such as a least-squares method may be used.

In the first ion exchange treatment, the temperature of the first molten salt is preferably from 360° C. to 400° C., and the ion exchange time is preferably from 30 minutes to 6 hours. In the second ion exchange treatment, the temperature of the second molten salt is preferably from 370° C. to 400° C., and the ion exchange time is preferably from 15 minutes to 3 hours. The ion exchange time of the second ion exchange treatment is preferably shorter than the ion exchange time of the first ion exchange treatment. This is because when the ion exchange time of the second ion exchange treatment is too long, the maximum depth of compression DOC1 of the thin portion 2 is too large, and it becomes difficult to increase the maximum compressive stress value CS1.

The embodiment of the present invention is described above. However, the embodiment of the present invention is not limited thereto and may be variously modified within the range not departing from the gist of the present invention.

In the above-mentioned embodiment, a case in which the chemically tempered glass sheet and the glass sheet to be chemically tempered each comprise Li₂O as the glass composition is described as an example, but there is no limitation to this. The chemically tempered glass sheet and the glass sheet to be chemically tempered may each be substantially free of Li₂O as the glass composition.

Specifically, the chemically tempered glass sheet and the glass sheet to be chemically tempered may each comprise as the glass composition, in terms of mol %, 40% to 80% of SiO₂, 10% to 30% of Al₂O₃, 0% to 3% of B₂O₃, 5% to 25% of Na₂O, 0% to 5.5% of K₂O, 0% to 0.09% of Li₂O, and 0% to 10% of MgO.

Even in the case of the glass sheet to be chemically tempered that is substantially free of Li₂O as the glass composition as described above, the first ion exchange treatment and the second ion exchange treatment are preferably performed as the ion exchange treatment step. In this case, each of the first molten salt used in the first ion exchange treatment and the second molten salt used in the second ion exchange treatment preferably contains KNO₃. The concentration of KNO₃ in the first molten salt is preferably higher than the concentration of KNO₃ in the second molten salt. The ion exchange time of the first ion exchange treatment is preferably longer than the ion exchange time of the second ion exchange treatment. When such ion exchange treatment is performed, at the thin portion 2 of the chemically tempered glass sheet 1, the maximum compressive stress value CS1 can be increased by introduction of a K ion during the second ion exchange treatment. In addition, at the thick portion 3 of the chemically tempered glass sheet 1, the maximum compressive stress value CS2 can be increased by introduction of a K ion during the second ion exchange treatment while the maximum depth of compression DOC2 is increased by introduction of a K ion during the first ion exchange treatment.

### EXAMPLES

A glass article according to the present invention is described below by way of Examples. The following Examples are merely examples, and the present invention is by no means limited to the following Examples.

An alkali aluminosilicate glass having the following glass composition A and an alkali aluminosilicate glass having the following glass composition B were prepared as glass sheets to be chemically tempered. Each of the glass sheets to be chemically tempered comprises a thin portion (thickness t1) and a thick portion (thickness t2).

### (Glass Composition A)

The glass composition A contains, in terms of mol %, 60.35% of SiO₂, 18.90% of Al₂O₃, 0.20% of B₂O₃, 7.20% of Li₂O, 8.20% of Na₂O, 0.40% of K₂O, 0.40% of MgO, 4.30% of P₂O₅, and 0.05% of SnO₂.

### (Glass Composition B)

The glass composition B contains, in terms of mol %, 66.38% of SiO₂, 11.5% of Al₂O₃, 0.5% of B₂O₃, 0.02% of Li₂O, 15.2% of Na₂O, 1.4% of K₂O, 4.8% of MgO, 0.1% of CaO, and 0.1% of SnO₂.

The above-mentioned glass sheets to be chemically tempered were subjected to ion exchange treatment under conditions shown in Table 1 to produce chemically tempered glass sheets, and various stress characteristics were evaluated. Nos. 1 to 4 are Examples of the present invention, and No. 5 is Comparative Example.

TABLE 1

| | | No. 1 | No. 2 | No. 3 | No. 4 | No. 5 |
|---|---|---|---|---|---|---|
| Glass composition | | A | A | A | A | B |
| Thickness t1 of thin portion | | 20 | 60 | 130 | 30 | 20 |
| [μm] | | | | | | |
| Thickness t2 of thick portion | | 550 | 550 | 550 | 200 | 550 |
| [μm] | | | | | | |
| First ion | Molten salt | K70/Na30 | K70/Na30 | K70/Na30 | Na100 | K100 |
| exchange | [mass %] | | | | | |
| treatment | Temperature | 380 | 380 | 380 | 380 | 390 |
| | [° C.] | | | | | |
| | Time [min] | 60 | 60 | 60 | 40 | 20 |
| Stress | CS2 [MPa] | 404 | 406 | 395 | 361 | 940 |
| characteristics | DOC2 [μm] | 108 | 97 | 86 | 40 | 5.3 |
| of thick portion | DOC2/t2 | 0.20 | 0.18 | 0.16 | 0.20 | 0.01 |
| after first ion | CT2 [MPa] | 54 | 53 | 57 | 66 | 11 |
| exchange | Measurement | SLP | SLP | SLP | SLP | FSM |
| treatment | apparatus | | | | | |
| Stress | CS1 [MPa] | Not | Not | Not | Not | 730 |
| characteristics | | measured | measured | measured | measured | |
| of thin portion | DOC1 [μm] | Not | Not | Not | Not | 2.8 |
| after first ion | | measured | measured | measured | measured | |
| exchange | DOC1/t1 | Not | Not | Not | Not | 0.14 |
| treatment | | measured | measured | measured | measured | |
| | CT1 [MPa] | Not | Not | Not | Not | Not |
| | | measured | measured | measured | measured | measured |
| | Measurement | — | — | — | — | FSM |
| | apparatus | | | | | |
| Second ion | Molten salt | K100 | K100 | K100 | K100 | — |
| exchange | [mass %] | | | | | |
| treatment | Temperature | 380 | 380 | 380 | 380 | — |
| | [° C.] | | | | | |
| | Time [min] | 40 | 40 | 40 | 40 | — |
| Stress | CS2 [MPa] | 990 | 965 | 945 | 915 | — |
| characteristics | DOC2 [μm] | 92.1 | 93.3 | 90.1 | 33 | — |
| of thick portion | DOC2/t2 | 0.17 | 0.18 | 0.16 | 0.17 | — |
| after second ion | CT2 [MPa] | 61 | 62 | 61 | 71 | — |
| exchange | Measurement | FSM + SLP | FSM + SLP | FSM + SLP | FSM + SLP | — |
| treatment | apparatus | | | | | |
| Stress | CS1 [MPa] | 810 | 820 | 810 | 715 | — |
| characteristics | DOC1 [μm] | 2.2 | 4.1 | 4.5 | 4.5 | — |
| of thin portion | DOC1/t1 | 0.11 | 0.07 | 0.03 | 0.15 | — |
| after second | CT1 [MPa] | Not | Not | Not | Not | — |
| ion exchange | | measured | measured | measured | measured | |
| treatment | Measurement | FSM | FSM | FSM | FSM | — |
| | apparatus | | | | | |

For each of Nos. 1 to 4, the first ion exchange treatment and the second ion exchange treatment were performed, that is, the ion exchange treatment was performed twice in total. For No. 5, only the first ion exchange treatment was performed, that is, the ion exchange treatment was performed once in total.

For each of Nos. 1 to 4, the stress characteristics were measured twice in total after the first ion exchange treatment and the second ion exchange treatment. For No. 5, the stress characteristics were measured once in total only after the first ion exchange treatment.

In Table, “K70/Na30” means that the ion exchange treatment is performed through immersion in a molten salt having a KNO₃ concentration of 70 mass % and a NaNO₃ concentration of 30 mass %. “Na100” means that the ion exchange treatment is performed through immersion in a molten salt having a NaNO₃ concentration of 100 mass %. “K100” means that the ion exchange treatment is performed through immersion in a molten salt having a KNO₃ concentration of 100 mass.

In Table, “FSM” means FSM-6000LE manufactured by Orihara Industrial Co., Ltd. “SLP” means SLP-2000 manufactured by Orihara Industrial Co., Ltd. “FSM+SLP” means the use of FSM-6000LE and SLP-2000, and the stress characteristics were determined by synthesizing the measurement results with the two measurement apparatus.

From the results of Table 1, it is recognizable that the depth (DOC2) of the compressive stress layer at the thick portion of each of Examples Nos. 1 to 4 is much larger than the depth (DOC2) of the compressive stress layer at the thick portion of Comparative Example No. 5. In addition, in Comparative Example No. 5, the conditions of the ion exchange treatment were set with reference to the thin portion, but it is recognizable that the depth (DOC1) of the compressive stress layer at the thin portion of each of Examples Nos. 1 to 4 is comparable to the depth (DOC1) of the compressive stress layer at the thin portion of Comparative Example No. 5, and is a satisfactory result. Accordingly, the chemically tempered glass sheet according to each of Examples Nos. 1 to 4 can achieve high impact resistance at both the thick portion and the thin portion while flexibility is secured at the thin portion. As a result, the chemically tempered glass sheet according to each of Examples Nos. 1 to 4 is suitable for applications such as a foldable device.

The glass compositions of Examples described above are each an example, and the invention of the present application is applicable even in, for the following glass composition C and glass composition D.

### (Glass Composition C)

The glass composition C contains, in terms of mol %, 68.2% of SiO₂, 9.5% of Al₂O₃, 0.1% of B₂O₃, 8.0% of Li₂O, 8.2% of Na₂O, 3.0% of K₂O, 3.0% of MgO, and 0.1% of SnO₂.

### (Glass Composition D)

The glass composition D contains, in terms of mol %, 66.9% of SiO₂, 15.6% of Al₂O₃, 1.7% of B₂O₃, 7.5% of Li₂O, 7.5% of Na₂O, 0.3% of K₂O, 0.4% of MgO, and 0.1% of SnO₂.

### REFERENCE SIGNS LIST

1 chemically tempered glass sheet
2 thin portion
3 thick portion
4 recessed groove
5 remaining portion
6 compressive stress layer
7 tensile stress layer

1. A chemically tempered glass sheet, comprising:
a thin portion;
a thick portion thicker than the thin portion; and
a compressive stress layer formed on a surface portion of each of the thin portion and the thick portion,
the chemically tempered glass sheet being bendable at the thin portion,
wherein the chemically tempered glass sheet has a relationship of DOC2>DOC1 and a relationship of DOC2/t2≥0.05, where DOC1 represents a maximum depth of compression of the thin portion, DOC2 represents a maximum depth of compression of the thick portion, and t2 represents a thickness of the thick portion.

2. The chemically tempered glass sheet according to claim 1, wherein the chemically tempered glass sheet has a relationship of DOC1/t1≤0.20, where DOC1 represents the maximum depth of compression of the thin portion and t1 represents a thickness of the thin portion.

3. The chemically tempered glass sheet according to claim 1,
wherein a thickness t1 of the thin portion is 0.01 mm or more and 0.2 mm or less, and
wherein the thickness t2 of the thick portion is more than 0.2 mm and 2.0 mm or less.

4. The chemically tempered glass sheet according to claim 1, wherein the chemically tempered glass sheet has a relationship of DOC2/DOC1≥5, where DOC1 represents the maximum depth of compression of the thin portion and DOC2 represents the maximum depth of compression of the thick portion.

5. The chemically tempered glass sheet according to claim 1,
wherein the maximum depth of compression DOC1 of the thin portion is from 2 μm to 20 μm, and
wherein the maximum depth of compression DOC2 of the thick portion is from 10 μm to 200 μm.

6. The chemically tempered glass sheet according to claim 1,
wherein a maximum compressive stress value CS1 of the thin portion is from 100 MPa to 1,500 MPa, and
wherein a maximum compressive stress value CS2 of the thick portion is from 200 MPa to 2,000 MPa.

7. The chemically tempered glass sheet according to claim 1, wherein the chemically tempered glass sheet has a relationship of CS2/CS1≤20, where CS1 represents a maximum compressive stress value of the thin portion and CS2 represents a maximum compressive stress value of the thick portion.

8. The chemically tempered glass sheet according to claim 1, wherein a stress profile in a depth direction of the compressive stress layer of the thick portion has a bending point.

9. The chemically tempered glass sheet according to claim 1, wherein the chemically tempered glass sheet comprises as a glass composition Li₂O and Na₂O.

10. The chemically tempered glass sheet according to claim 9, wherein the chemically tempered glass sheet comprises as the glass composition, in terms of mol %, 50% to 80% of SiO₂, 8% to 25% of Al₂O₃, 0% to 10% of B₂O₃, 3% to 15% of Li₂O, 3% to 21% of Na₂O, 0% to 10% of K₂O, 0% to 10% of MgO, and 0% to 15% of P₂O₅.

11. A method of producing a chemically tempered glass sheet comprising a thin portion, a thick portion thicker than the thin portion, and a compressive stress layer formed on a surface portion of each of the thin portion and the thick portion, the chemically tempered glass sheet being bendable at the thin portion, the method comprising:
a preparation step of preparing a glass sheet to be tempered comprising the thick portion and the thin portion; and
an ion exchange treatment step of subjecting the glass sheet to be tempered to two-stage ion exchange treatment,
wherein the ion exchange treatment step comprises performing the two-stage ion exchange treatment so that the chemically tempered glass sheet after the ion exchange treatment satisfies a relationship of DOC2>DOC1 and a relationship of DOC2/t2≥0.05, where DOC1 represents a maximum depth of compression of the thin portion, DOC2 represents a maximum depth of compression of the thick portion, and t2 represents a thickness of the thick portion.

12. The method of producing a chemically tempered glass sheet according to claim 11,
wherein the glass sheet to be tempered comprises as a glass composition Li₂O and Na₂O, and
wherein the ion exchange treatment step comprises: a first ion exchange treatment of performing ion exchange with a molten salt containing 10% or more of NaNO₃; and after the first ion exchange treatment, a second ion exchange treatment of performing ion exchange with a molten salt containing 30% or more of KNO₃.
